(19) United States
(12) Patent Application Publication
(10) Pub. No.: US 2015/0041321 A1
(43) Pub. Date: Feb. 12, 2015

(54) POLYACRYLAMIDE GEL FOR USE WITH TRADITIONAL AND NON-TRADITIONAL ELECTROPHORESIS RUNNING BUFFERS

(71) Applicants: John Lewis Andrews, Homebush, New Southwales (AU); Hani Nur, (US)

(72) Inventors: John Lewis Andrews, Homebush, New Southwales (AU); Hani Nur, (US)

(21) Appl. No.: 14/353,701

(22) PCT Filed: Feb. 4, 2012
(86) PCT No.: PCT/IB2012/000333

§ 371 Date: Oct. 9, 2014

(30) Foreign Application Priority Data
Oct. 23, 2011 (AU) 2011904379

(51) Int. Cl. G01N 27/447

(52) U.S. Cl. CPC G01N 27/44747
USPC 204/456

(57) ABSTRACT

Disclosed are gel systems prepared with a substantially neutral gel buffer solution, which contains an amine base and at least one zwitterionic component and an acid component. Methods of making and using these gel systems are also disclosed herein.

### CROSS REFERENCE TO RELATED APPLICATIONS

This application claims the benefit of priority to Australian application No. 2011904379, filed Oct. 23, 2011, which is incorporated by reference herein in its entirety.

### FIELD

This disclosure relates to the field of gel electrophoresis, particularly to pre-cast polyacrylamide gels having improved buffer combinations for gel electrophoresis.

### BACKGROUND

Electrophoresis is the fundamental technique for both analytical and preparative separation of charged molecules under the influence of an electric field. The technique is applicable to all charged biomolecules including ribonucleic acids (DNA, RNA), poly-amino-acids (peptides, proteins), as well as charged carbohydrates and lipids. In the analysis of biological samples, the most common format of the technique uses a gel as the support matrix. Agarose or polyacrylamide are the gel supports normally used in this technique. Frequently, the supporting matrix is cast as individual slabs immediately prior to use. A number of systems have been established for preparation of the gel slabs that may be stored for a period of time before use.

Most commonly, polyacrylamide gels are prepared by polymerising a monomer solution, comprising acrylamide, cross-linker, buffer, and additives, in a gel-casting cartridge where the buffer is at an alkaline pH adjusted with monoprotic acids. These gels are then run under alkaline conditions, often with a denaturant such as sodium dodecyl sulphate (SDS), after which the biomolecules may be visualized, identified, recovered or quantified by a range of methods. A traditional choice for a gel recipe would be that of Laemmli (Nature 227:680-686, 1970), who developed a buffer system using a mixture of the free-base and chloride salt of tris(hydroxymethyl)aminomethane, commonly referred to as tris- hydrochloride or TrisHCl. Polyacrylamide gels of this type are comparatively unstable with a limited storage life. This shortcoming of increased instability of polyacrylamide gels prepared under alkaline conditions was well known but was thought to be inevitable in standard gels.

It is known that lowering the pH of the gel matrix buffer to near neutrality will greatly reduce the hydrolysis of the polyacrylamide in the gel matrix. The consequence of a change to lower pH is that the gel matrix has extended stability and a longer useful life on storage. As the buffering capacity of Tris-HCl is reduced as the pH is lowered towards neutrality, most commercially available pre-cast gels with extended shelf life of significantly greater than 3 months, do not utilize Tris-HCl. Consequently, several different neutral pH buffer systems have been developed for use with polyacrylamide gels.

A common neutral pH buffer system used in electrophoresis gels is the phosphate system modified by Weber and Osborn (J Biol Chem 244(16):4406-4412, 1969) from Shapiro (Biochem Biophys Res Commun 28:815, 1967). A neutral “aminediol” gel buffer was described in U.S. Pat. Nos. 4,415,655 and 4,481,094 based on the primary amine, 2-amino-2-methyl-1,3-propanediol with monoprotic acids. These gels were run in high pH buffers containing 2-amino-2-methyl-1,3-propanediol taurine. Other gel buffers have been described (see U.S. Pat. Nos. 5,578,180 and 5,922,185) that involve primary substituted organic amines with a pKa near neutrality. The preferred amine is Bis-Tris (bis-(2-hydroxyethyl)iminotris(hydroxymethyl)methane). This buffer system has both the gel and running buffer at a near neutral pH. U.S. Pat. No. 6,059,948 is a continuation-in-part of these patents and discloses the use of a similar near neutral gel buffer consisting of an amine with pKa near neutrality and a zwitterionic base with a pK_{b} between 6 and 9.

Another approach described in U.S. Pat. No. 3,948,743 is the use of a strongly ionizable neutral salt, preferably ammonium sulfate. These gels need to be pre-run in the buffer that is desired for separation to remove the salt before application of the sample which is an inconvenience of this method that would appear to have acted against its commercialization.

U.S. Pat. No. 6,733,647 is perhaps the only system to use TrisHCl at neutral pH as they found that by manipulating the conventional Tris-HCl buffer system, stable gels can be prepared that have comparable separation characteristics, when used with an electrode buffer comprising Tris(hydroxymethyl) aminomethane and 4-(2-hydroxyethyl)piperazine-lethanesulphonic acid (HEPES); as standard gels but having the advantage of long shelf-life.

U.S. Pat. No. 5,464,516 states that when the pH of the gel buffer is neutral or lower the performance of separating the proteins according to molecular weight is deteriorated. This patent describes a near neutral gel buffer comprising of an acid, amine and an ampholyte that has the same number of anionic and cationic groups in each single molecule, that provides a wide separation range and stability.

All of the above neutral gels that are not based on the TrisHCl gel buffer utilize electrode buffers comprising a single sulphonic acid zwitterionic component with Tris base. BioRad have produced a neutral gel that can use the Tris-glycine running buffer by substitution of triethanalolamine for Tris as the main gel buffer component as well as the inclusion of an ampholyte. This follows from U.S. Pat. No. 6,726,821 in which TrisHCl gels are supplemented with glycine and at least one conjugate ampholyte in a gel of pH 6.0 and 6.8.

### SUMMARY

In accordance with the purposes of the disclosed materials and methods, as embodied and broadly described herein, the disclosed subject matter, in one aspect, relates to compounds, compositions and methods of making and using compounds and compositions. In further aspects, the disclosed subject matter relates to a gel system comprising a substantially neutral gel buffer solution, which is run primarily with an electrophoretic buffer comprising an amine base and at least one zwitterionic component and an acid component of the buffer. Methods of making and using these gel systems are also disclosed herein.

The disclosed gel systems can be run in a number of buffer systems; however, using the Tris-glycine-SDS system, the gels perform as expected for a gel of a higher pH. The combination of zwiterionic component and acid provides improved band shape at high R_{f}. The use of different combinations of amine base and zwitterion component in the gel buffer and/or different combinations of acids in the running buffer can be tailored for improved separation in different ranges of molecular weight for the same polyacrylamide concentration.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF FIGURES

The accompanying figures, which are incorporated in and constitute a part of this specification, illustrate several aspects described below.

FIG. 1 shows a comparison of eggwhite run in gels (images top and electrophoretograph bottom) of the test formulation with three mineral acids (hydrochloric acid, sulphuric acid, and phosphoric acid).

FIG. 2 shows images of gels from the same formulation batch run in Tris-glycine-SDS buffer at different voltages: (a) 200 V, 45 minutes and (b) 250 V, 30 minutes.

FIG. 3 shows a comparison of resolution of a Tris-glycine gel as disclosed herein (A) and standard Laemmli gel (B) run at 250 V with Tris-glycine-SDS buffer. Lanes 1 and 6 are Invitrogen Mark 12 protein MW markers. Lanes 2-3 are Gallus Gallus egg white. Lanes 4-5 are Pisum sativum (snow pea) protein extract. Lanes 7-8 are Gallus Gallus egg white dilute. Lanes 9-10 are E. coli lysate. Lanes 11-12 are human plasma. The disclosed Tris-glycine gel system displayed straight, distinct bands (A). The standard Laemmli gel displayed uneven, distorted bands (B).

FIG. 4 shows the R_{f} versus time data at 37° C. storage for four proteins run in gels of a test batch of the current formulation versus a representative protein in a standard Laemmli formulation.

FIG. 5 shows a 4-20% Tris-glycine gel as disclosed herein stored at 37° C. for 4 months and that has been run with Tris-Glycine buffer. Lanes 1-4 and 8-10 are Pisum sativum (snow pea) protein extract, lane 5 is dilute egg white protein, lane 6 is blank, and lane 7 is egg white protein.

FIG. 6 shows images (A-E) of gels run in 50 mM Tris buffers containing an equal concentration of acetate, MES, MOPS, HEPES, and tricine, respectively. In each part of the figure, lane 1 is an extract of E. coli, lane 2 is an extract of peas, and lane 3 contains a set of marker proteins.

FIG. 7 shows a Tris-glycine 4-20% gel as disclosed herein run in different buffers: Tris-MES-SDS, Tris-MOPS-SDS, Tris-glycine-SDS. Panel A shows a comparison of lanes with Invitrogen Mark 12 standard. Panel B shown a comparison of lanes with Pisum sativum (snow pea) protein extract with the bands in 3 different molecular weight regions marked.

FIG. 8 shows images (A-C) of gels run in 50 mM Tris buffers containing an equal concentration of mixed zwitterionic counterions MES-HEPES, MOPS-HEPES, and MOPS-MES, respectively. In each part of the figure, lane 1 is an extract of E. coli, lane 2 is an extract of peas, and lane 3 contains a set of marker proteins.

FIG. 9 shows the migration pattern of protein standard between a Tris-glycine 4-20% gel as disclosed herein (A), a Bio-Rad TGX 4-20% gel (B), and an Invitrogen NuPAGE 4-12% gel (C). Each gel was run under the conditions recommended by the manufacturer. The molecular weight markers were 200, 116, 97, 66, 55, 33, 31, 21, 14, 6, 3.5, and 2.5 kDa.

FIG. 10 shows a comparison of resolution between Tris-glycine gel as disclosed herein (A, D), a Bio-Rad TGX 4-20% gel (B, E), and an Invitrogen NuPAGE 4-12% gel (C, F). Each gel was run under the conditions recommended by the manufacturer. Pisum sativum (snow pea) protein extract was separated and the number of protein bands and spacing between bands was compared. Left (A, B, C): full lane comparison. Right (D, E, F): the region between 55 and 33 kDa indicating increased banding and higher resolution for the disclosed gels.

FIG. 11 shows a neutral diethanolamine-glycine gel as disclosed herein run with Tris/glycine/SDS at pH 8.3

FIG. 12 shows a neutral Tris-glycine gel as disclosed herein run with Tris/glycine/SDS at pH 8.3.

FIG. 13 shows a neutral triisopropanolamine/HCl/glycine gel as disclosed herein run with Tris/glycine/SDS at pH 8.3.

### DETAILED DESCRIPTION

The materials, compounds, compositions, and methods described herein can be understood more readily by reference to the following detailed description of specific aspects of the disclosed subject matter, the Figures, and the Examples included therein.

Before the present materials, compounds, compositions, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the specification and claims the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a buffer” includes mixtures of two or more such buffers, reference to “an amine” includes mixtures of two or more such amines, reference to “the compound” includes mixtures of two or more such compounds, and the like.

“Optional” or “optionally” means that the subsequently described event or circumstance can or cannot occur, and that the description includes instances where the event or circumstance occurs and instances where it does not.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values can be used. Further, ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Unless stated otherwise, the term “about” means within 5% (e.g., within 2% or 1%) of the particular value modified by the term “about.”

By “Tris” is meant tris(hydroxymethyl)aminomethane. By “HEPES” is meant 4-(2-hydroxyethyl)piperazine-lethanesulphonic acid. By “MES” is meant 2-(N-morpholino)ethanesulfonic acid. By “ADA” is meant N-(2-acetamido)iminodiacetic acid. By “PIPES” is meant piperazine-N,N′-bis(2-ethanesulfonic acid). By “ACES” is meant N-(2-acetamido)-2-aminoethanesulfonic acid. By “MOPS” is meant 3-(N-morpholino)propanesulfonic acid. By “BES” is meant N,N-Bis(2-hydroxyethyl)-2-aminoethanesulfonic acid. By “TES” is meant 2-(N-morpholino)ethanesulfonic acid. By “CHES” is meant N-cyclohexyl-2-aminoethanesulfonic acid. By “tricine” is meant N-tris(hydroxymethyl)methylglycine. By “bicine” is meant N,N-bis(2-hydroxyethyl)glycine. By “EPPS” is meant 4-(2-hydroxyethyl) piperazine-1-propanesulfonic acid.

The terms “running buffer” and “electrode buffer” are used synonymously and refer to the solution used to provide contact between the electrodes and the gel when processing a sample through the gel by electrophoresis.

Disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that are possible are specifically contemplated unless specifically indicated to the contrary. Thus, if a class of components A, B, and C are disclosed as well as a class of components D, E, and F and an example of a combination composition A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

Reference will now be made in detail to specific aspects of the disclosed materials, compounds, compositions, articles, and methods, examples of which are illustrated in the accompanying Examples and Figures.

### Compositions

Disclosed herein are gel systems for use in the electrophoritic separation of molecules. The gel system comprises a gel and a gel buffer solution. The gel can be a polyacrylamide gel or agarose gel. The gels are substantially neutral and yet can be used with traditional Tris-glycine-SDS running buffers of alkaline pH. They can also be used with running buffers that are commonly used to run other neutral gels, as well as with buffers with mixtures of acid components.

The disclosed gels are prepared in a gel buffer solution as disclosed herein. For example, the disclosed gels can be prepared by supplementing Tris, or an alternative secondary or tertiary amine base, in a neutral gel with a zwitterionic component, as disclosed herein. As noted, the disclosed gels perform similar to gels of higher pH when using Tris-glycine-SDS running buffer system.

The pH of the disclosed gels can be from about 6.0 to about 9.5. More specifically, the pH of the gels can be from about 6.5 to about 7.5. In other examples, the pH of the disclosed gels can be about 6.0, 6.5, 7.0, 7.5, 8.0, 8.5, 9.0, or 9.5, where any of the stated values can form an upper or lower endpoint of a range.

The gels can be prepared by polymerization of acrylamide using standard techniques. The acrylamide can also be mixed with a cross-linker (e.g., N,N′-methylene bis-acrylamide).

### Gel Buffer Solution

The gel buffer solution disclosed herein comprises an amine base, a zwitterionic component, and an acid component. The pH of the disclosed gel buffer solutions can be from about 6.0 to about 9.5. More specifically, the pH of the gel buffer solution can be from about 6.5 to about 7.5. In other examples, the pH of the disclosed gel buffer solution can be about 6.0, 6.5, 7.0, 7.5, 8.0, 8.5, 9.0, or 9.5, where any of the stated values can form an upper or lower endpoint of a range.

In one aspect, disclosed are gel buffer solutions can comprise an amine base at a concentration of from about 0.005 M to about 0.25 M and a zwitterionic component at a concentration of from about 0.005 M to about 0.5 M, titrated with an acid component to a pH of from about 6.0 to about 9.5. In another example, the gel buffer solutions can comprise amine base at a concentration of from about 0.025 to about 0.15 M and a zwitterionic component at a concentration of from about 0.05 to about 0.4 M, titrated with an acid component to a pH of from about 6.5 to about 7.5.

### Amine Base

In the disclosed gel buffer solutions, the amine base can be a primary, secondary or tertiary amine Preferably the amine is a hydroxylated alkyl amine. Examples of suitable include amine bases include, but are not limited to, tris(hydroxymethyl)aminomethane, diethanolamine, tiisopropanolamine other tri-alcoholamines, preferably with branched alkyl chains. The presence of different amine bases can confer individual separation characteristics due to the interaction of the amine with the sample.

A suitable amine base can have a pKₐ from about 7.5 to about 10, for example, about 7.5, 7.7, 8.0, 8.2, 0.5, 8.7, 9.0, 9.2, 9.5, 9.7, or 10, where any of the stated values can form an upper or lower endpoint of a range. Further, the amine base does not have a pKₐ of near neutrality.

In the disclosed gel buffer solutions, the amine base can be present at a concentration of from about 0.005 M to about 0.25 M. For example, the amine base can be present at a concentration of from about 0.005 M to about 0.10 M, from about 0.01 M to about 0.15 M, from about 0.05 M to about 0.20 M, from about 0.1 M to about 0.25 M, from about 0.05M to about 0.15 M, from about 0.005 M to about 0.05 M, and from about 0.15 M to about 0.25 M. Still further, the amine base can be present at a concentration of about 0.005, 0.010, 0.050, 0.10, 0.15, 0.20, and 0.25 M, where any of the stated values can form an upper or lower endpoint of a range.

In a specific example, the gel buffer solution can have a pH of from about 6.0 to about 9.5 and can comprise the amine base tris(hydroxymethyl)aminomethane at a concentration of from about 0.005 to about 0.25 M. In another example, the gel buffer solution can have a pH of from about 7.5 to about 8.5 and can comprise the amine base tris(hydroxymethyl)aminomethane at a concentration of from about 0.025 to about 0.15 M. In a further example, the gel buffer solution can comprise the amine base tris(hydroxymethyl)aminomethane at a concentration of from about 0.025 to about 0.05 M.

### Zwitterion Component

In the disclosed gel buffer solutions, the zwitterionic component can be present as an acid of the buffer pair. It is preferred that the zwitterionic component is glycine. However, glycine can be substituted with other zwitterionic components, which can include, but are not limited to, alanine, β-alanine, γ-aminobutyric acid, MES, ADA, PIPES, ACES, MOPS, cholamine chloride, BES, TES, CHES, HEPES, acetamido glycine, tricine, glycinamide, bicine, EPPS, imidazole-HEPES, and other common amino-acids. It is also possible to use mixtures of these zwitterionic components.

A suitable zwitterion can have a pKₐ of greater than about 9.0, for example, greater than about 9.2, 9.4, 9.6, 9.8, 10.0, 10.2 or above. In certain examples the zwitterion can have a pKₐ of from about 9.1 to about 10, from about 9.3 to about 10.3, from about 9.5 to about 10.5, or from about 9.1 to about 9.9.

In the disclosed gel buffer solutions, the zwitterionic component can be present at a concentration of from about 0.005 M to about 0.50 M. For example, the zwitterion can be present at a concentration of 0.005 M to about 0.30 M, from about 0.01 M to about 0.35 M, from about 0.05 M to about 0.40 M, from about 0.10 M to about 0.45 M, from about 0.15 M to about 0.50 M, from about 0.05 M to about 0.25 M, from about 0.005 M to about 0.25 M, from about 0.10 M to about 0.35 M, and from about 0.10 M to about 0.30 M. Still further, the amine base can be present at a concentration of about 0.005, 0.010, 0.050, 0.10, 0.15, 0.20, 0.25, 0.30, 0.35, 0.40, 0.45, and 0.50 M where any of the stated values can form an upper or lower endpoint of a range. The zwitterionic components can be run as individual counterions to the amine base or in multiple combinations.

### Amine to Zwitterion Ratio

The molar ratio of amine to zwitterion at a specific pH in the gel buffer solution affects the overall distribution of proteins of varying molecular weight. Using Tris-glycine as an example, at pH 7 in a gel run with standard Tris-glycine-SDS running buffer, and amine/zwitterions ratio of 0.36 produced a relatively even distribution from 2 kDa to >200kDa. A lower ratio shifts the distribution higher on the gel (lower R_{f} values) and higher ratios shifts the distribution lower on the gel (higher R_{f} values). Provided the ratio remains constant the total buffer component concentration can be varied to adjust the time required to run the gel at a fixed applied voltage in a given buffer system. Lower concentration results in faster running time and lower current draw and, conversely, higher concentration results in a slower run time and higher current draw.

In general the ratio of amine to zwitterion can be from about 0.1 to about 100, for example about 0.01, 0.05, 0.1, 0.5, 1, 1.5, 2, 2.5, 5, 10, 15, 20, 25, 30, 40, or 50, where any of the stated values can form an upper or lower endpoint of a range. Acid Component

The acid component comprises a polyprotic acid. The polyprotic acid can be a mineral or an organic acid. In other examples, the acid component can comprise additional acids, including monoprotic acids. Specific examples of suitable polyprotic acids include, but are not limited to, sulphuric acid (H₂SO₄), sulfurous acid (H₂SO₃), phosphoric acid (H₃PO₄), malic acid, citric acid, and oxalic acid. One or more of these polyprotic acids can be used in the acid component. Other acids that can be a part of the acid component are chosen from one or more of acetic acid, formic acid, nitric acid (NHO₃), hydrochloric acid (HCl ), hydrobromic acid (HBr), and perchloric acid (HClO₄).

The amount of acid used depends on the desired pH of the gel buffer solution and/or gel system. Generally and amount sufficient to attain a pH of from 6.0 to 9.5, for example, 6.5 to 7.5 is used.

### Running Buffer Solution

The electrode buffer solution disclosed herein comprises an amine base and a zwitterionic component as the acid component. The pH of the disclosed electrode buffer solutions can be from about 6.0 to about 9.5. The disclosed gels can be best used with standard Tris-glycine-SDS electrode buffer. Other running buffers that can be used are Tris-Tricine, Tris-HEPES, Tris-MES, Tris-MOPS, Tris-acetate, and combinations thereof. The zwitterionic components can be run as individual counterions to the amine base or in multiple combinations. So specific examples of zwitterionic mixtures that can be used include, but are not limited to, MES-HEPES, MOPS-HEPES, and MOPS-MES.

### Method of Making

The disclosed gel systems can be prepared by polymerizing acrylamide in the presence of a cross-linker and a gel buffer solution. An initiator is also used to induce polymerization. Any suitable initiator can be used to induce polymerization of the gels. Suitable initiators include, but are not limited to, redox systems such as ammonium persulfate (APS) and N,N,N,′N′-tetramethylethylenediamine (TEMED), photoinitiation systems such as riboflavin, thermal initiators using (APS), as well as other less commonly used systems.

By way of example, the disclosed gel systems can be prepared by polymerizing acrylamide in the presence of N,N′-methylene bis-acrylamide and a gel buffering system comprising Tris-glycine such that the concentration of Tris in the final system is about 0.1 M and the concentration of glycine in the final system is about 0.275 M. The pH of the gel buffer solution can be adjusted with H₂SO₄ such that the pH is about 7.0. Initiation of the polymerization can be achieved by redox initiation with APS and TEMED. A typical example of the acrylamide concentrations in these gels is a separating gel of 12% T/4% C with a stacking gel comprised of 5% T/4% C. Any suitable acrylamide concentrations can, however, be used in the disclosed compositions and methods. For example, the preparation of a 12% homogeneous gel, the following recipe can be used. A stacking gel solution (5% T/4% C) and a resolving gel solution (12% T/4% C) can be prepared with a buffer of 100 mM amine (e.g., Tris), 275 mM zwitterion (e.g., glycine) with the pH of adjusted to 7.0 by adding an acid (e.g., sulphuric acid to about 45 mM).

### Methods of Use

The disclosed gel systems can be used in the electrophoretic separation of molecules. Thus, disclosed herein are methods of performing electrophoresis, comprising: (a) applying a sample containing one or more compounds to be separated to a gel of an electrophoresis apparatus whereby the gel, e.g., a separating polyacrylamide gel, with or without a stacking polyacrylamide gel, contains a gel system as disclosed herein; (b) providing a running buffer; and (c) subjecting the gel to an electric field for sufficient time such that at least one compound in the sample is caused to move into the gel.

As noted the disclosed gels can be used with standard Tris-glycine-SDS running (electrode) buffer. Other running buffers that can be used are Tris-Tricine, Tris-HEPES, Tris-MES, Tris-MOPS, Tris-acetate, and combinations thereof.

The disclosed gel systems allow them to be run without distortion due to heat at higher voltage than the standard Laemmli gels, resulting in a shorter analysis time and increased resolution than was previously possible. Thus, disclosed herein are methods of using the disclosed gel systems for electrophoretic separation of a sample wherein the voltage is at or greater than about 150 V, for example, 175 V, 200 V, 225 V, or 250 V. It is also possible to apply a voltage of greater than about 250 V. Of course voltage at 150 V can be used. The higher voltage reduces the run time to less than about 90 minutes, for example at or less than 60 minutes, 45 minutes, 30 minutes, or 15 minutes, while maintaining a high resolution.

### EXAMPLES

The following examples are set forth below to illustrate the methods, compositions, and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process. Only reasonable and routine experimentation will be required to optimize such process conditions.

In the following examples, gels were prepared in mini cassettes (80 mm×100 mm) to produce a gel of 1 mm thickness. The solutions used in polymerization were prepared by mixing stock solutions of acrylamide/bis- acrylamide and the appropriate buffer and adding water to dilute to the appropriate concentration.

### Example 1

Polyacrylamide gels were cast with a gel buffer comprising 0.1 M Tris and 0.275 M glycine and the pH of the gel buffer was adjusted to 7.0 using either HCl, H₂SO₄ or H₃PO₄. A number of different samples were separated on this gel using an electrode buffer of 25 mM Tris, 192 mM glycine, and 0.1%(w/v)SDS. The protein samples included an aqueous protein extract of snow pea, chicken egg white, and a commercially available marker set.

Gel systems as disclosed herein were run with Tris-glycine-SDS buffer (25 mM Tris, 192 mM glycine, 0.1% SDS. All other gels were run according to manufactures instructions. Tris-MES-SDS buffer was prepared to 50 mM and 1% SDS final concentration. Tris-MOPS-SDS buffer was prepared to 50 mM and 1% SDS final concentration.

| Gel | voltage | run time | current (start/end) |
|---|---|---|---|
| Tris-glycine | 250 V | 30 min | 100/45 mA |
| Standard Laemmli gel | 150 V | 90 min | 100/45 mA |

### Example 2

Polyacrylamide gels were cast with a gel buffer comprising 0.05 M Tris and 0.138 M glycine and the pH of the gel buffer was adjusted to 7.0 using either HCl, H₂SO₄ or H₃PO₄. A number of different samples were separated on this gel using an electrode buffer of 25 mM Tris, 192 mM glycine, and 0.1% (w/v)SDS. The protein samples included an aqueous protein extract of snow pea, chicken egg white, and a commercially available marker set.

### Example 3

Polyacrylamide gels were cast with a gel buffer comprising 0.1 M diethanolamine and 0.275 M glycine and the pH of the gel buffer was adjusted to 7.0. A number of different samples were separated on this gel using an electrode buffer of 25 mM Tris, 192 mM glycine, and 0.1% (w/v)SDS. The protein samples included an aqueous protein extract of snow pea, chicken egg white, and a commercially available marker set.

### Example 4

Polyacrylamide gels were cast with a gel buffer comprising 0.1 M triisopropanolamine and 0.275 M glycine and the pH of the gel buffer was adjusted to 7.0. A number of different samples were separated on this gel using an electrode buffer of 25 mM Tris, 192 mM glycine, and 0.1% (w/v)SDS. The protein samples included an aqueous protein extract of snow pea, chicken egg white, and a commercially available marker set.

### Example 5

Polyacrylamide gels were cast with a gel buffer comprising 0.1 M Tris and 0.275 M β-alanine and the pH of the gel buffer was adjusted to 7.0. A number of different samples were separated on this gel using an electrode buffer of 25 mM Tris, 192 mM glycine, and 0.1% (w/v)SDS. The protein samples included an aqueous protein extract of snow pea, chicken egg white, and a commercially available marker set.

### Example 6

Polyacrylamide gels were cast with a gel buffer comprising 0.1 M Tris and 0.275 M γ-aminobutyric acid and the pH of the gel buffer was adjusted to 7.0. A number of different samples were separated on this gel using an electrode buffer of 25 mM Tris, 192 mM glycine, and 0.1% (w/v)SDS. The protein samples included an aqueous protein extract of snow pea, chicken egg white, and a commercially available marker set.

### Example 7

A Tris-glycine gel as disclosed herein can be run in a range of different buffers, each producing a different migration pattern. The electrode buffers tested including Tris-acetate, Tris-MES, Tris-MOPS, Tris-HEPES, Tris-Tricine and combinations thereof. These electrode buffers were prepared to 50 mM or 100mM and 1% SDS final concentration.

### Results

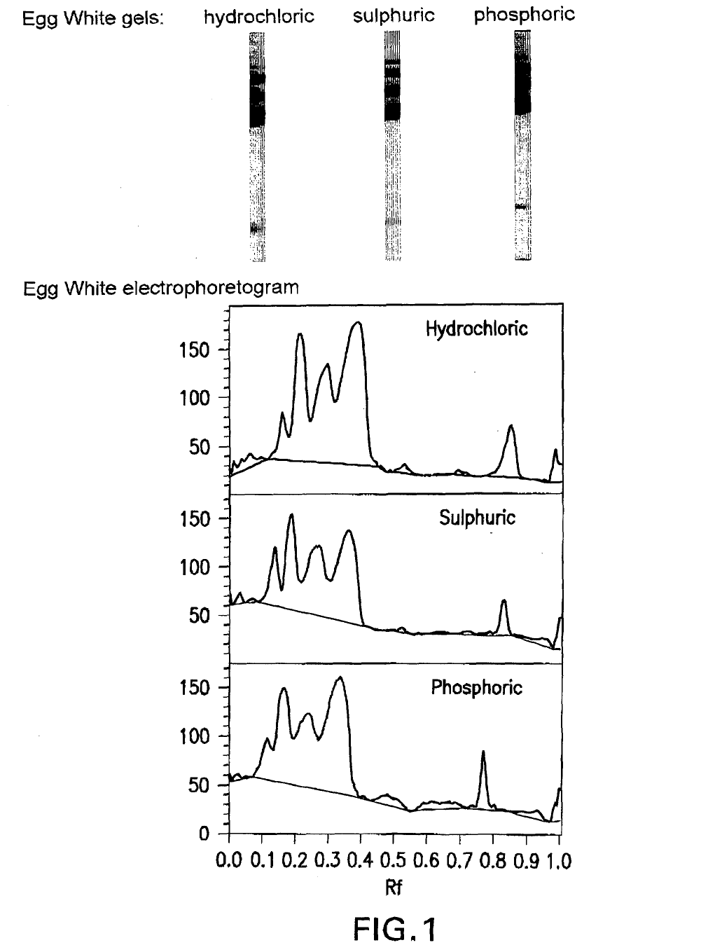

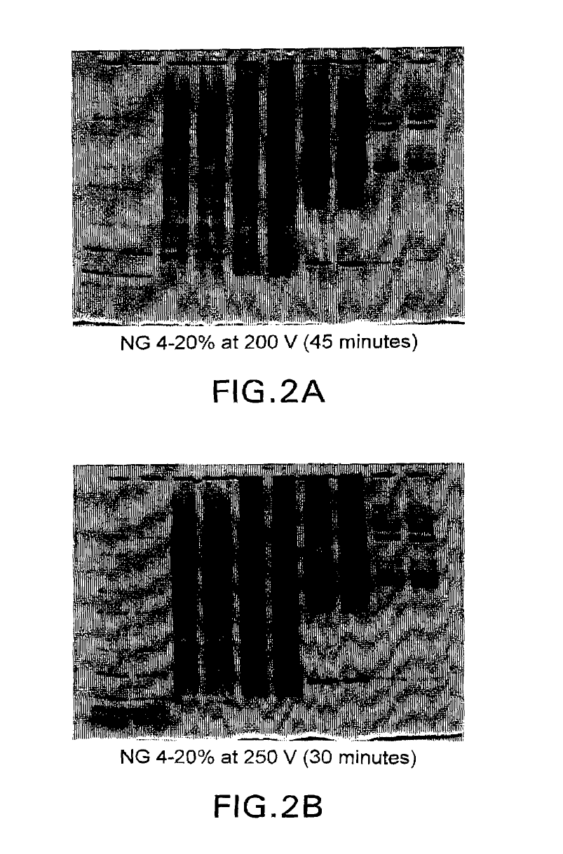

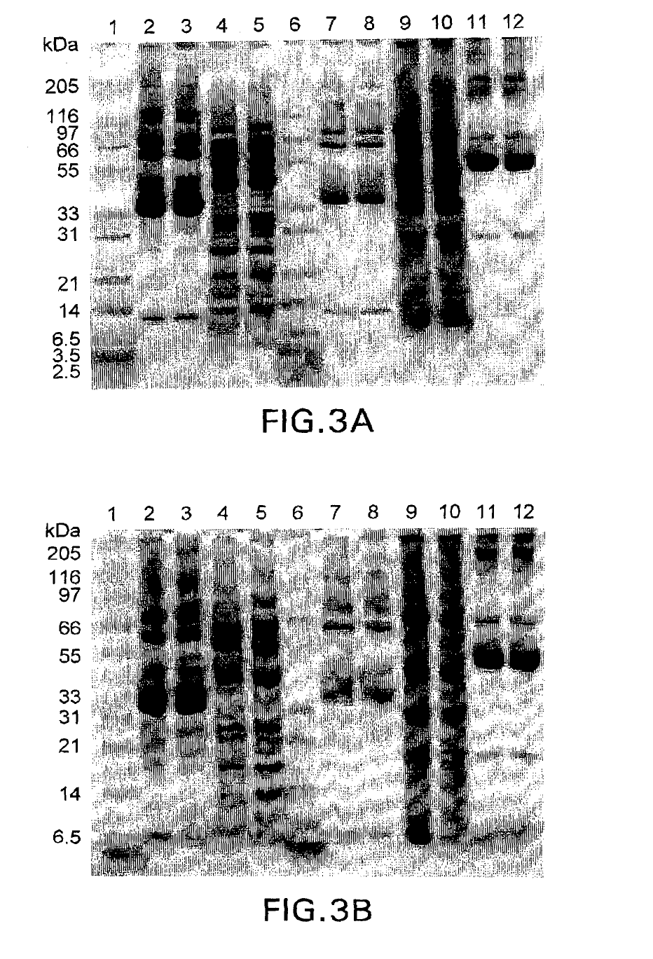

To illustrate combinations of amine concentration and zwitterion concentration at neutral pH that provide acceptable results, a series of experiments were performed where the amine concentration was varied in the range 0.05-0.175 M, the zwitterion concentration was varied in the range 0.125-0.275 M at neutral pH. An example experiment was performed where gels were made with an acrylamide concentration of 4-20% and an amine, Tris, concentration of 0.100 M, the zwitterion, glycine, concentration of 0.275 M and the pH adjusted to 7.0 with a of acids, HCl, H₂SO₄, and H₃PO₄. The resulting gels were run with 25 mM Tris/192 mM glycine/1% SDS. The relative migration (R_{f}) of proteins of varying molecular weight were similar to those observed with a standard Laemmli formulation gel. The polyprotic acid formulations provided an improvement in band shape for the higher R_{f} species (FIG. 1). The gels formulated with the polyprotic acids also had slightly increased run times at the same voltage, but as they drew less current during electrophoresis they can be run at higher voltage to shorten the time to complete a run (FIG. 2, FIG. 3).

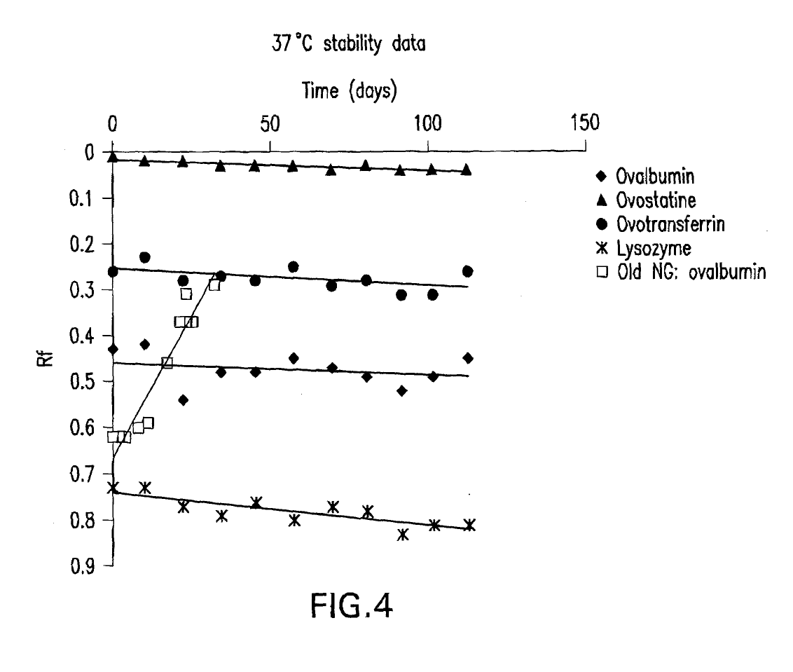

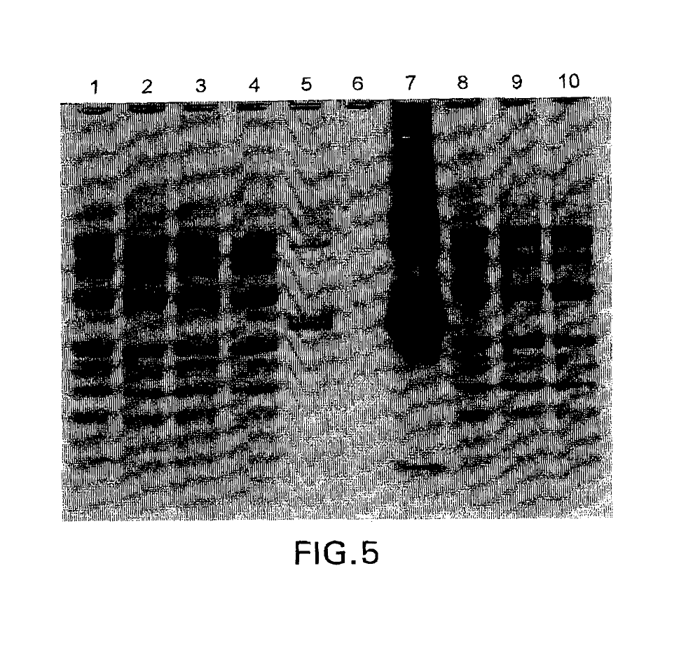

The stability of these gels was examined over time by the performance of the gels in the Tris-Glycine buffer system of Laemmli. It was found that the stability was significantly improved compared with a standard Laemmli formulation (FIG. 4, FIG. 5). Gels run in Tris-Glycine-SDS displayed exceptional stability when used after more than 12 months of storage at 2-8° C. The gels remained stable over storage time in relation to the sharpness of the protein bands as well as the relative migration of the proteins (FIG. 5). In standard, Laemmli formulation gels, there was significant alteration in the R_{f} value storage time, as illustrated in FIG. 4).

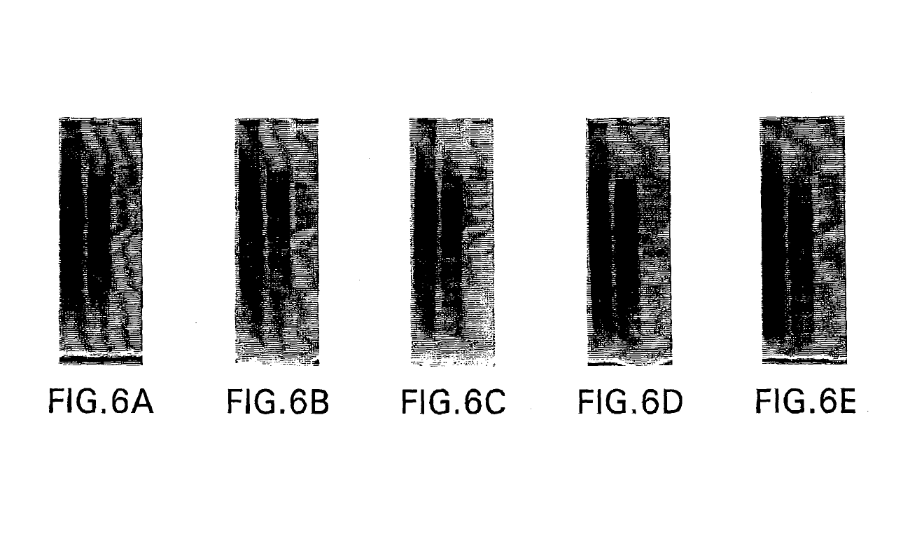

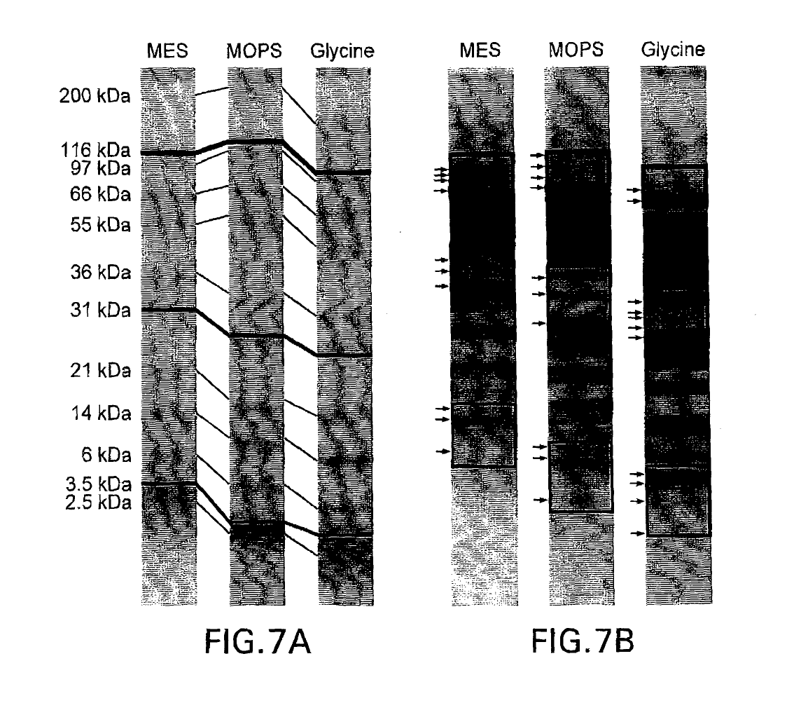

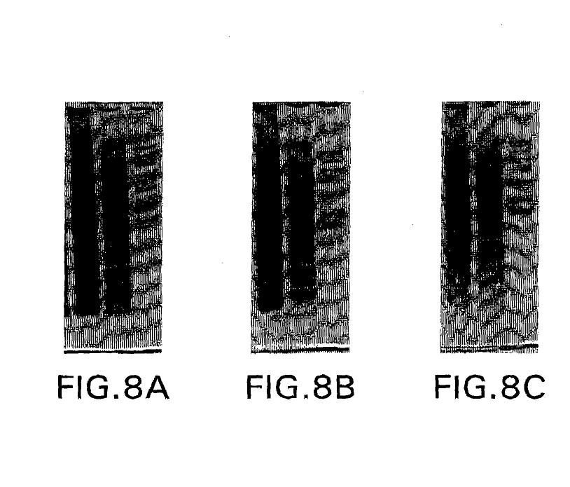

Although the gels produced as disclosed herein were compatible with traditional SDS electrode buffers such as that of Laemmli (Tris-Glycine) and Schagger and von Jagow (Tris-Tricine), they can also be used with a wide variety of electrode buffers. Other systems have also been tested including Tris-acetate, Tris-MES, Tris-MOPS, Tris-HEPES, Tris-Tricine (FIG. 6, FIG. 7) and combinations thereof (FIG. 8). In use, the gels have differing behavior in these various electrode buffer systems to produce an acceptable variance in the separation patterns achieved. The resolution of proteins in all of the electrode-buffer systems tested was found to be excellent. The results indicate that the R_{f} of proteins is extended with increasing pKₐ of the acid species within the sulphonate and carboxyl acid series. Generally, buffer anions of higher pKₐ will result in lower R_{f} values for a set of proteins in comparison to the same protein set run with a buffer of lower pKₐ anions. Different molecular weight regions can be highlighted by selecting an appropriate buffer. Combinations of acids can be chosen to accentuate the separation in particular regions of the molecular weight spectrum (FIG. 8).

Consequently, there is flexibility for the application of the gel systems as disclosed herein. From the favorable results with many, quite different, running (electrode) buffer systems, other running buffer systems are likely to be compatible with the gel systems disclosed herein. It will be appreciated that the running (electrode) buffer systems that can be used are not limited to the examples that have been mentioned.

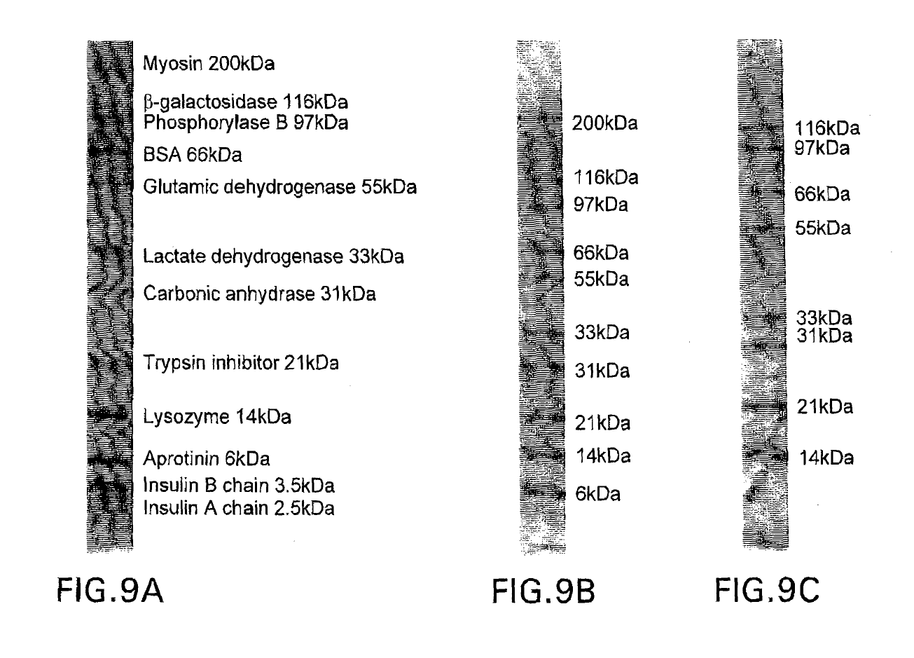

Migration patterns were compared between Tris-glycine gel as disclosed herein and two commercial neutral gel formulations using the separation of a set of molecular weight markers (FIG. 9). At the lower molecular weight region 4-2 kDa, the disclosed gel systems achieved higher resolution than the TGX and NuPAGE gels with both insulin chains completely resolved. Separation with the disclosed gel systems is achieved across the entire length of the gel, providing a broader molecular weight range from 200 kDa to 2 kDa.

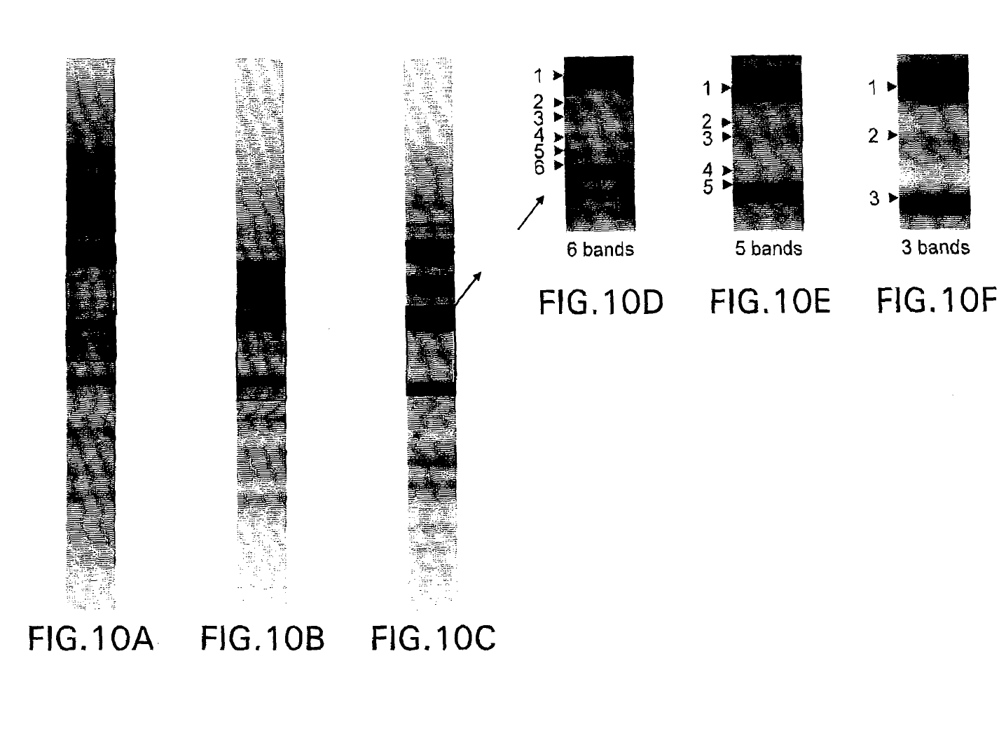

Resolution was compared between the disclosed Tris-Glycine gel system and two commercial neutral gel formulations for the analysis of Pisum sativum extract. Comparision of the banding pattern indicated an increased resolution for the disclosed gels, evident by the increase in number of protein bands separated (FIG. 10). This shows the disclose gel system is able to better destack protein bands than other precast gels.

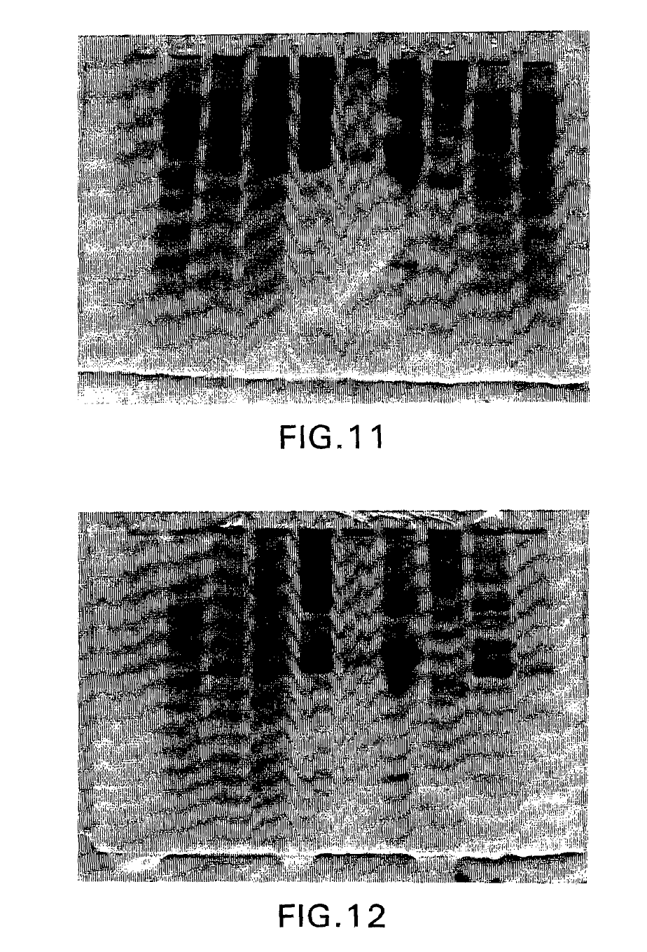

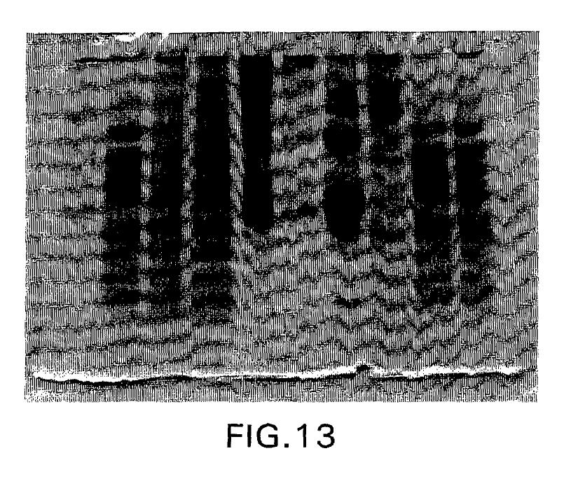

The amine of the gel buffer solution in the current invention can be primary, secondary or tertiary. Preferably the amine is a hydroxylated alkyl amine Examples tested include, tris(hydroxymethyl)aminomethane, diethanolamine, triisopropanolamine The presence of different amines confer individual separation characteristics due to the interaction of the amine with the sample, as illustrated in FIG. 11, 12, 13, noting particularly the complex sample (extract of legume pea) analysed in lane two of the figures where additional bands are visible in the triisopropanolamine formulation.

The zwitterionic species can primarily be glycine, but this can be substituted by other zwitterionic components. Gels produced according to the disclosed methods with β-alanine or γ-aminobutyric acid substituted for glycine resulted in gels that when run with the standard Tris-glycine-SDS buffer system resulted in extended R_{f} values for a given protein. The increase observed being in relation to the length of the carbon chain and thus the increasing pKₐ value of the acid group.

The molar ratio of amine to zwitterion at a specific pH in the gel buffer affects the overall distribution of proteins of varying molecular weight. Using Tris and glycine as an example, at pH 7 in a gel run with standard Tris-glycine-SDS, an amine/zwitterion ratio of 0.36 results in a relatively even distribution of proteins from 2 kDa to greater than 200 kDa across the gel (FIG. 9). A lower ratio shifts the distribution higher on the gel (lower R_{f} values) and higher ratios shifts the distribution lower on the gel (higher R_{f} values). Provided the ratio remains constant the total buffer component concentration can be varied to adjust the time required to run the gel at a fixed applied voltage in a given buffer system. Lower concentration results in faster running time and lower current draw and, conversely, higher concentration results in a slower run time and higher current draw.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of preparing a gel system, the method comprising: polymerizing acrylamide in the presence of a cross-linking agent and a gel buffer solution, wherein the gel buffer solution comprises an amine base at a concentration of from about 0.005 to about 0.25 M and a zwitterionic component at a concentration of from about 0.005 to about 0.5 M titrated with an acid component that comprises a polyprotic acid to a pH of from about 6.0 to about 9.5.

2. The method of claim 1, wherein the gel buffer solution has a pH of from about 7.5 to about 8.5.

3. The method of claim 1, wherein the gel buffer solution has a pH of from about 6.5 to about 7.5.

4. The method of claim 1, wherein the gel buffer solution comprises the amine base at a concentration of from about 0.025 to about 0.15 M and the zwitterionic component at a concentration of from about 0.05 to about 0.4 M titrated with the acid component to a pH of from about 6.5 to about 7.5.

5. The method of claim 1, wherein the amine base is a primary, secondary or tertiary amine.

6. The method of claim 1, wherein the amine base is a primary, secondary or tertiary amine with a hydroxylated side chain.

7. The method of claim 1, wherein the amine base is an alcoholamine with branched alkyl chains.

8. The method of claim 1, wherein the amine base is Tris(hydroxymethyl)aminomethane, ethanolamine, diethanolamine, isopropanolamine, diisopropanolamine, or triisopropanolamine.

9. The method of claim 1, wherein the amine base has a pKₐ of from about 7.5 to about 10.0.

10. The method of claim 1, wherein the zwitterionic component is glycine.

11. The method of claim 1, wherein the zwitterionic component is one or more of glycine, alanine, β-alanine, γ-aminobutyric acid, MES, ADA, PIPES, ACES, MOPS, cholamine chloride, BES, CHES, TES, HEPES, acetamido-glycine, tricine, glycinamide, or bicine.

12. The method of claim 1, wherein the zwitterionic component has a pKₐ of greater than about 9.0.

13. The method of claim 1, wherein the polyprotic acid is one or more of malic acid, citric acid, oxalic acid, sulfurous acid (H₂SO₃), sulfuric acid (H₂SO₄), or phosphoric acid H₃PO₄.

14. The method of claim 1, wherein the acid component further comprises one or more of hydrochloric acid (HCl ), acetic acid, formic acid, nitric acid (NHO₃), hydrobromic acid (HBr), or perchloric acid (HClO₄)

15. The method of claim 1, wherein the gel buffer solution comprises Tris(hydroxymethyl)aminomethane as the amine base at a concentration of from about 0.005 M to about 0.25 M.

16. The method of claim 1, wherein the gel buffer solution comprises Tris(hydroxymethyl)aminomethane as the amine base at a concentration of from about 0.025 M to about 0.2 M.

17. The method of claim 1, wherein the gel buffer solution comprises Tris(hydroxymethyl)aminomethane as the amine base at a concentration of from about 0.05 M to 0.15 M.

18. (canceled)

19. (canceled)

20. A method of performing electrophoresis, comprising:
a. applying a sample containing one or more compounds to be separated to a gel of an electrophoresis apparatus whereby the gel is the gel system of any of claims 18-19;
b. providing a running buffer to the gel; and
c. subjecting the gel to an electric field for sufficient time such that at least one compound in the sample is caused to move into the gel.

21. (canceled)

22. The method of claim 20, wherein the running buffer comprises Tris(hydroxymethyl)aminomethane at a concentration of from about 0.005 M to about 0.25 M, titrated with an acid component to a pH between about 6.0 and 9.5.

23. (canceled)

24. (canceled)

25. The method of claim 20, wherein the zwitterionic component present as the acid of the buffering pair is glycine, MES, ADA, PIPES, ACES, MOPS, Cholamine chloride, BES, TES, HEPES, Acetamidoglycine, Tricine, Glycinamide, Bicine, γ-amino-butyric acid, alanine, β-alanine, Bicine, EPPS, Imidazole-HEPES, or other amino-acid.

26. (canceled)
